(19) United States
(12) Patent Application Publication
(10) Pub. No.: US 2010/0314865 A1
(43) Pub. Date: Dec. 16, 2010

(54) JOINING METAL PIPES

(75) Inventors: Stephen Hatton, Woking (GB); Simon Luffrum, Woking (GB)

Correspondence Address: BURR & BROWN, PO BOX 7068, SYRACUSE, NY, 13261-7068, US

(73) Assignee: 2H Offshore Engineering Limited, Woking (GB)

(21) Appl. No.: 12/747,714

(22) PCT Filed: Dec. 12, 2008
(86) PCT No.: PCT/GB2008/004128

§ 371 Date: Sep. 1, 2010

(30) Foreign Application Priority Data
Dec. 14, 2007 (GB) 0724406.4

(51) Int. Cl. F16L 55/00; F16L 23/00

(52) U.S. Cl. 285/187; 285/412

(57) ABSTRACT

A metal pipe 10 is joined to another metal component 12 by shrinking the outer component onto the external circumference of the pipe. The internal diameter b of the outer component is initially smaller than the external diameter a of the pipe, but the outer component is heated so that it expands to a diameter at which it will fit over the pipe. When the outer component is fitted over the pipe and the temperature of the outer component allowed to drop, it will contract onto the surface of the pipe to make a permanent strong joint between the two parts.

### FIELD OF THE INVENTION

This invention relates to a method for structurally and sealingly making a joint between two tubular metal components, for example to connect a flange or other type of mechanical coupling onto the end of a metal pipe. Such a method could be used to connect couplings onto the end of high pressure pipes used in deep water riser systems used in offshore oil and gas extraction.

### BACKGROUND TO THE INVENTION

Risers are long tubular structures assembled from steel pipe. They must resist high service loads resulting from self weight, environmental and operational loads. In service risers are constantly moving and cyclically loaded and therefore structural integrity and resistance to long term fatigue loading is critical.

A riser joint is a length of pipe typically 10-15 m long (or significantly longer) with connectors welded on both ends. The riser is constructed by connecting such pipes end to end to form a riser string. This may be typically up to 2000 m long (or significantly longer) depending on water depth.

As water depths increase the self weight of the riser, which the riser must resist and the rig must support, increases both due to the increased length and the increase in pipe wall thickness that is required to resist axial and pressure loads. This is particularly true for risers used for high pressure wells which require high burst resistance and thus the need for thick pipe walls.

The thick wall not only presents a weight problem but it complicates the welding process typically used for connecting the coupling onto the pipe end. Thick welds have worse metallurgical performance than thinner welds due to the number of weld passes, heat input and probability of defects. Thus international design codes require a fatigue reduction factor where welds are conducted in material with wall thickness greater than approximately 25 mm.

To reduce this wall thickness and the riser joint weight, higher strength materials are used for the pipe and coupling. However as material yield strength increases so typically do the welding problems and ability to achieve acceptable material properties in the weld and the adjacent heat affected zones. Currently, the industry is limited to welding pipe material with an 80,000 psi yield whilst achieving acceptable properties and resistance to issues such as susceptibility to H₂S cracking.

It is an aim of the present invention to overcome at least one problem associated with the prior art whether referred to herein or otherwise.

### SUMMARY OF THE INVENTION

According to a first aspect of the present invention, there is provided a method of joining one tubular metal component inside another such that the joined components are concentric, with a first larger diameter component surrounding a second smaller diameter component, wherein the internal diameter of the first component is chosen to be equal to or slightly smaller than the external diameter of the second component when both components are at ambient temperature, either the first component is heated, or the second component is cooled or both the first component is heated and the second component is cooled such that the internal diameter of the first component is slightly larger than the external diameter of the second component, the first component is fitted over the second component while their temperatures are different, and the temperatures of the components are allowed to reach equilibrium so that the first and second components are in contact with one another over circumferential contact surfaces, wherein the contact surfaces between the components are machined with a surface profile prior to assembly.

This method allows higher strength steel to be used with thinner walled pipes whilst meeting load specifications and long term fatigue performance. No welding is needed.

The method can be used to join a coupling to the end of a high strength pipe, typically 110,000 psi yield or even higher. The coupling, which is typically a flange, is thermally shrunk onto the pipe end in a manner that creates a high strength connection and simultaneously provides a high integrity metal to metal seal adequate to resist high internal and external pressures. The shrinking process is achieved by creating a large temperature differential between the pipe and the coupling (for example by heating the flange to a high temperature and simultaneously cooling the pipe). The hot flange is then slid over the cold pipe end and both components are allowed to reach thermal equilibrium at atmospheric temperature. During this process the flange shrinks and/or the pipe expands creating a high contact force between the two components. The contact force is sufficient to structurally connect the two items and form a high strength connection between the two.

The internal diameter of the first component is preferably chosen to be slightly smaller than the external diameter of the second component when both components are at ambient temperature.

The first component can be heated by resistance heating and the second component can be cooled using liquid nitrogen.

The components may be mounted in a jig before being fitted together so that the jig guides the components as they are fitted together.

Preferably resistance to separation of the first component and the second component comprises resistance provided by friction between the two components.

Preferably resistance to separation of the first component and the second component comprises a force generated between grooves and ribs provided on the two components.

Preferably resistance to separation of the first component and the second component comprises a force generated between locking elements located in a retaining passageway defined between the two components.

Preferably resistance to separation of the first component and the second component comprises a sum of resistances provided by friction between the two components, a force generated between grooves and ribs provided on the two components and a force generated between locking elements located in a retaining passageway defined between the two components.

The invention also provides a riser pipe comprising a plurality of riser sections each having flanges connected to pipes by the method set out above, with the flanges connected to one another as well as a riser section comprising a length of pipe and flanges fitted at each end by the method set out above, wherein the flanges have holes through which bolts can be passed to secure riser sections end to end.

According to a second aspect of the present invention, there is provided an assembly comprising a first tubular metal component and a second tubular metal component, the assembly comprising the second component being secured inside the first component such that the joined components are concentric, wherein the first component comprises a larger diameter which surrounds the second smaller diameter component, the internal diameter of the first component is equal to or slightly smaller than the external diameter of the second component when both components are at ambient temperature, prior to assembly the first component is heated, or the second component is cooled or both the first component is heated and the second component is cooled such that the internal diameter of the first component is slightly larger than the external diameter of the second component, the first component is fitted over the second component while their temperatures are different, and the temperatures of the components are allowed to reach equilibrium so that the first and second components are in contact with one another over circumferential contact surfaces, wherein the contact surfaces between the components are machined with a surface profile prior to assembly.

The first component may comprise a flange. The second component may comprise a pipe and preferably comprises an end of a pipe.

Preferably the flange provides an inner circumferential contact surface for engaging with a circumferential contact surface provided on an outer surface of the pipe.

The first component may comprise a series of engaging grooves provided on an inner surface thereof. The second component may comprise a series of engaging ribs provided on an outer surface thereof. Preferably the or each engaging rib engages with a corresponding engaging groove in the assembled configuration.

The or each engaging rib may be a continuous circumferential rib.

The or each engaging rib may be non-continuous. The or each rib may be a breached rib.

The or each rib may provide a helical or threaded configuration.

The or each engaging groove may be a continuous circumferential groove.

The or each engaging groove may be non-continuous. The or each groove may be a breached groove.

The or each groove may provide a helical or threaded configuration.

The or each engaging rib may comprise a generally rectangular or square profile. The ribbed surface may provide a castellated engaging surface.

The or each engaging groove may comprise a generally rectangular or square profile. The grooved surface may provide a castellated engaging surface.

The first component may comprise a retaining groove for at least partially retaining a locking element or a series of locking elements therein.

The second component may comprise a retaining groove for at least partially retaining a locking element or a series of locking elements therein.

Preferably a retaining groove provided on the first component is arranged to register with a retaining groove provided on the second component in order to define a retaining passageway in which locking elements are located in the assembled configuration. Preferably the retaining passageway is an annular retaining passageway.

Preferably the or each retaining groove may comprise a generally semi-circular groove.

Preferably the or each locking element comprises a generally spherical locking element. Preferably the or each locking element comprises a ball bearing.

The first component may comprise a port for enabling locking elements to be introduced into the retaining passageway.

### BRIEF DESCRIPTION OF THE DRAWINGS

The invention will now be further described, by way of example, with reference to the accompanying drawings, in which:

FIG. 1 is a schematic view of two components prior to assembly by the method of the invention;

FIG. 2 is a cross-section through a joint in accordance with the invention;

FIG. 3 is a perspective view of the joint of FIG. 2;

FIG. 4 is a view corresponding to FIG. 1 and showing additional features;

FIG. 5 is a view corresponding to FIG. 2 and showing additional features;

FIG. 6 is a perspective cut away view of another embodiment of two components prior to assembly;

FIG. 7 is a perspective cut away view of another embodiment of two components once assembled; and

FIG. 8 is a cross section of the interface between another embodiment of two components once assembled.

### DESCRIPTION OF THE PREFERRED EMBODIMENTS

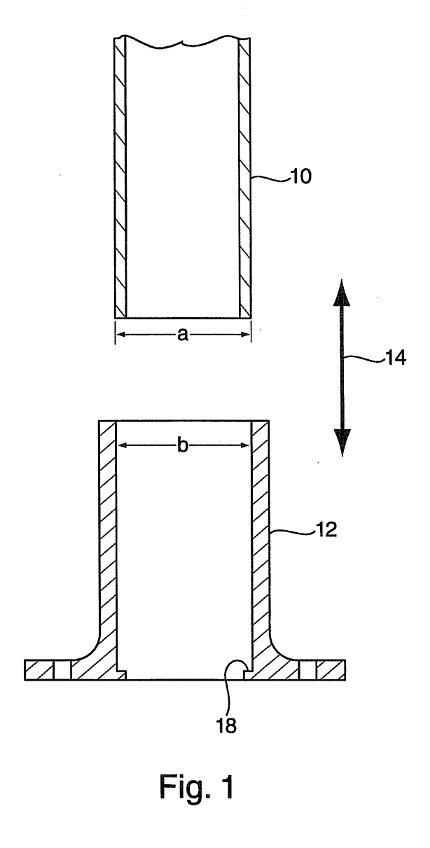

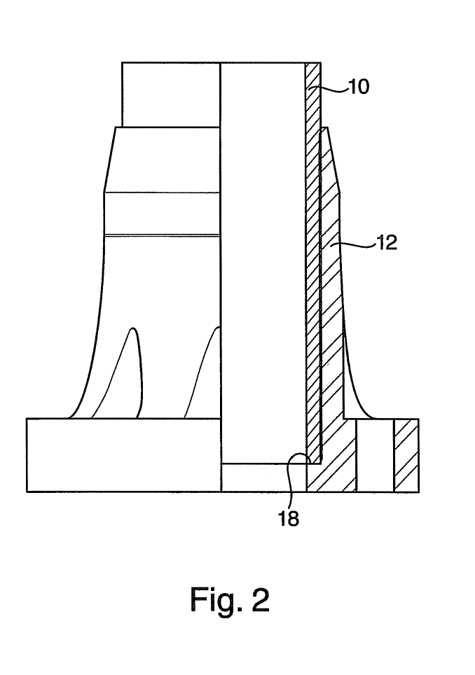

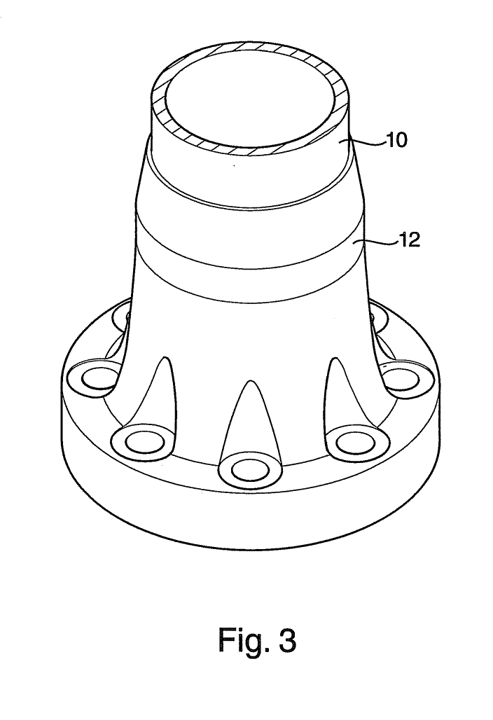

FIG. 1 shows an end section 10 (the second component) of a much longer pipe and a flange component 12 (the first component). The external diameter of the pipe 10 is indicated at a and the internal diameter of the flange component 12 is indicated at b.

The external surface of the pipe end section 10 and the internal surface of the flange component 12 will be accurately machined to achieve the desired relationship between the diameters a and b. When both components are at the same temperature, diameter b will normally be slightly smaller than diameter a, such that the pipe will not fit into the bore of the flange component. However the relationship will be chosen, taking into account the coefficients of expansion of the components such that when there is a significant temperature differential between the flange (hotter) 12 and the pipe (cooler) 10, the pipe will just fit inside the flange component 12. The components 10, 12 are then fitted together as indicated by the arrow 14 while the temperature differential is maintained, and they are then allowed to reach thermal equilibrium. When this happens, the flange component 12 shrinks onto the pipe end 10 to form a mechanically strong and pressure tight sealed engagement between the components 10, 12.

The proposed design covers the method of connecting flange couplings onto the end of thick walled high strength pipe in a manner that forms a structurally high capacity connection.

The design relies on machining the outside diameter of the ends of the pipe 10 to an accurate diameter with a tight tolerance. The flange coupling 12 is machined with a pocket ending in a shoulder 18 into which the pipe 10 is inserted. Alternatively, the shoulder 18 may be eliminated and the pipe 10 inserted the full length of the flange 12 until the tapered section between the machined and unmachined pipe section mates snugly with the mating profile on the inside diameter of the flange neck. This is important to maximise structural capacity and minimise stress concentration factors that can reduce fatigue performance. It is probable that where the shoulder 18 is eliminated and the pipe 10 passes through the entire length of the flange 12 that the pipe end 10 will need to be finish machined after assembly. Where the pipe 10 is finish machined after assembly it is possible to extend the initial length of the pipe 10 and include a tapered section for guidance to ease assembly.

The bore of the flange 12 is machined to be smaller than the outside diameter of the pipe 10 and with tightly controlled diametrical machining tolerance. The length of the flange neck is important to achieve an adequate contact area between the flange 12 and the pipe 10 and it is also machined with a tapering wall thickness to minimise stress concentration factors at the interface between the pipe body and commencement of the flange neck and also within the flange body itself.

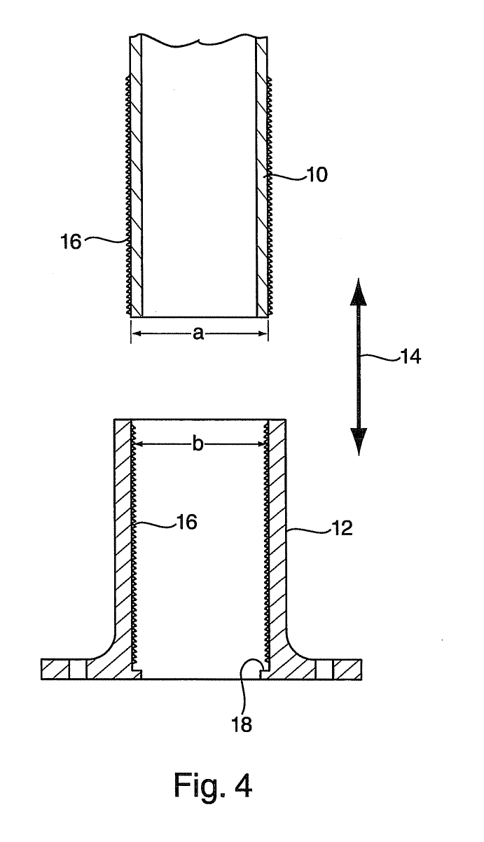

The contact surface between the pipe 10 outside diameter and flange bore may be machined with a surface profile (16, FIG. 4) to increase the friction coefficient between the two components 10, 12, depending on required structural capacities. This may consists of a random surface finish or a series of circumferential grooves typically 0.1 mm height and 0.1 mm pitch. These grooves interlock and deform under mating of the flange and increase the resistance of the flange to external load and can help to enhance sealabilty.

An optional locking mechanism can also be included in the design (FIG. 5). This consists of a series of ball bearings 21 that are inserted into a machined groove 20 through an external port 22 in the flange body 12. These ball bearings 21 provide additional confidence that the flange 12 cannot be pulled from the pipe 10 by high external loads. The port 22 can also be used as a pressure test port to allow confirmation of seal integrity between the pipe 10 and flange neck.

The flange body 12 design itself can be designed in accordance with standard flange design practices with respect to seal ring grooves and bolting.

The flange 12 is assembled onto the end of the pipe 10 by first heating the flange 12 using electric resistance mats typically used for weld pre and post weld heat treatment. Simultaneously the end of the pipe 10 may be cooled using ice or liquid nitrogen.

As the temperature difference between the flange 12 and pipe 10 is increased the bore of the flange 12 becomes greater than the outside diameter of the pipe 10. This allows the flange 12 to be fitted over the end of the pipe 10. The temperature of the flange 12 must be carefully controlled so that it does not exceed a threshold beyond which the material properties of the flange base material are impaired.

As soon as the hot flange is brought into close contact with the cold pipe, heat is transferred from the flange 12 to the pipe 10. Therefore it is essential that the mating process (arrow 14) is conducted rapidly and in a single movement or else there is a danger that the flange 12 will become stuck on the pipe 10 before it gets to its fully engaged position.

To prevent this assembly problem a jig is used to accurately align the flange 12 and pipe 10 and which can then smoothly and quickly push the flange 12 onto the pipe 10 and hold pressure on the assembled parts until the temperatures have reached equilibrium.

As the flange 12 shrinks and the pipe 10 expands a high contact force is generated at the interface between the two components 10, 12. The force is defined by the selected dimensions and machining tolerances and is pre-selected such that the contact pressure, coupled with the appropriate coefficient of friction ensures that the flange 12 is permanently fixed to the pipe 10 and is able to withstand pressure and applied external forces of similar capacity to the pipe body.

The exclusion of welds from the flange 12 to pipe body 10 connection procedure allows a high fatigue performance to be achieved since parent metal S-N curves can be assumed rather than those related to weld properties.

Whilst the design proposed is based on a flange it is apparent that the same method can be used to connect other types of coupling onto a pipe end and in fact the method can be used as a collar simply to permanently connect two pipe sections to make a longer length.

The method described above can provide the following advantageous characteristics which can overcome difficulties with existing designs:
Allow thick walled pipe to be connected without welding
Avoid poor fatigue performance resulting from thick welds
Allow connection of high strength non weldable steels
Allow non compatible pipe and coupling materials to be connected
Allow lighter pipes and risers to be designed and constructed
Allow risers with higher internal pressure rating to be designed and constructed.

The present invention provides a shrink fit flange connection 11 which is designed as a system for connecting pipes 10 and tubular components to flange bodies 12 or hubs. A main use of the present invention is for use in joining assemblies including dissimilar metals, high strength or heavy wall thickness steels which inhibit the use of welding for the joining method. In particular, the present invention provides a method and apparatus for use in a drilling riser which may be operating with high pressure fluids in which the materials to be joined are not weldable and may include very thick pipes.

The present invention provides a method of joining parts by shrink fitting using temperature difference between two parts 10, 12 to create a gap allowing assembly of oversize shafts into holes. The present invention provides embodiments which may use three additional separate locking systems. These locking systems may include balls in groove, ribs/grooves and/or different surface finishes at positions along the bore.

Overall, the two components 10, 12 may be prevented from becoming disconnected initially by a frictional force between the circumferential contact surfaces, this is reinforced by corresponding ribs 24 and grooves 26 which further prevent the components from becoming disconnected and this may also be backed up by a ball and groove securement system. This would effectively provide a three stage reinforcement connection between the components 10, 12 to prevent unintentional or accidental separation of the components. For example, as a disconnecting force is applied to the assembly the frictional forces would initially prevent relative movement. As the force increases, the ribs 24 defined on the outer surface of the pipe 10 would abut and engage the corresponding grooves 26 provided on the inner surface of the flange 12. Furthermore, if the separation force continues to increase, the ball bearings 21 then act to prevent relative movement between the pipe 10 and the flange 12. Accordingly, the force that the assembly 11 can withstand is defined by the sum of the resistive forces provided by the frictional surfaces, the ribs 24 and grooves 26 and also by the ball bearings 21 and grooves 20. All of these three resistive forces are greatly enhanced and increased by the shrink fit procedure.

In the present invention, the joint provides a resistive force to separation that increases as the two components are moved from the original assembled configuration. Initially, friction provides the resistive force and this is then increased due to the addition of the resistive force provided by the ribs and grooves and this is further increased due to the addition of the resistive force provide by the locking ball bearings and associated grooves. Accordingly, the resistance to separation increases as the two components move relative to each other. Assemblies relying solely on friction would tend to have a resistive force which would decrease once the two components staring moving or slipping relative to each other. In particular, in the present invention the load required doesn't just peak and then reduce as the pipe slips as it would if we relied on a friction fit only.

The assembly 11 also provides good sealing properties and this may be enhanced by providing an accurately machined and finished mating area located towards the end of the pipe 10 and the internal surface of the flange 12 adjacent to the shoulder 18. This may also comprise a first groove on the internal surface of the flange 12 to engage with a corresponding first rib provided on the pipe 10.

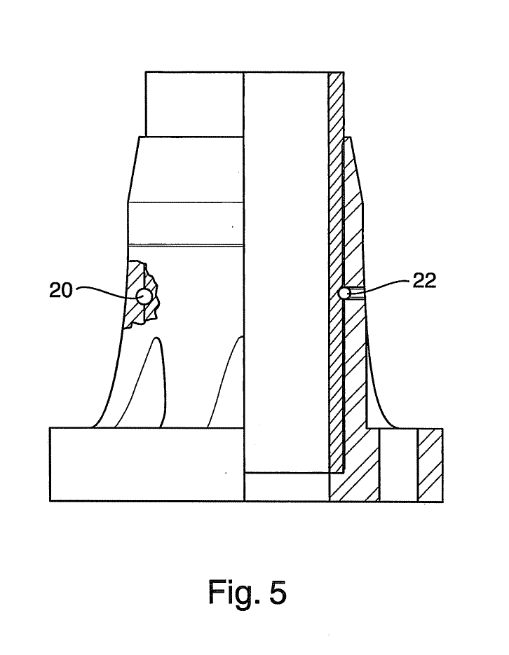

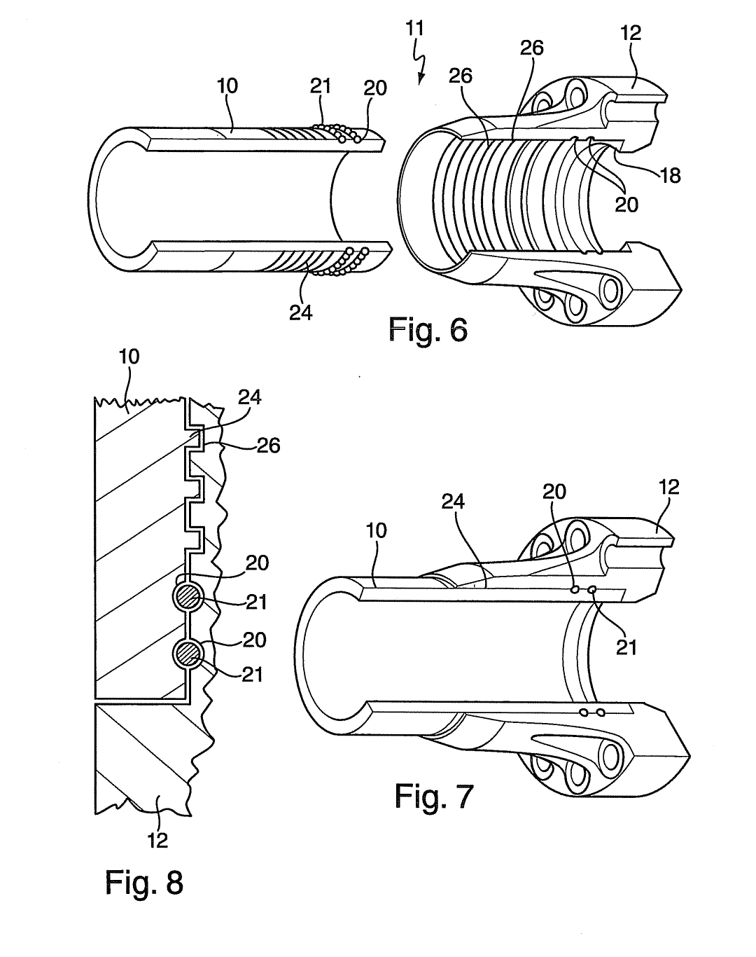

By way of further explanation, another embodiment of the present invention is shown in FIG. 6, FIG. 7 and FIG. 8. The assembly 11 comprises a first component 12 which is a flange body. The second component 10 comprises the end of an elongate pipe.

The second component 10 comprises a tubular member and is generally steel but could be made from other metallic alloys, aluminium, titanium etc. The outside diameter is machined with a series of ribs 24 of rectangular form and semi-circular grooves 20. In particular, the end of the pipe 10 comprises a specific surface finish and profile in order to secure the pipe 10 to the flange 12. The outside diameter is further split into a number of different zones. Each zone has a tightly controlled size and surface finish which are arranged to suit different functions. The bore is machined over nominal size by an amount dependent on operating conditions to give the required interference with the flange bore.

The first component 12 comprises a flange body and is generally a forged low alloy steel component. The internal bore is machined with a series of grooves of rectangular 26 and semi-circular form 20. The bore is further split into a number of different zones. Each zone has a tightly controlled size and surface finish which are arranged to suit different functions. The bore is machined to nominal size.

The second component 10 is locked to the first component 12 by a ball and groove method. The inner surface of the flange 12 includes at least one circumferential groove 20 defined therein. In the embodiment shown in FIG. 6, FIG. 7 and FIG. 8, the flange body 12 includes a first circumferential groove 20 and a second circumferential groove 20. Each circumferential groove 20 is generally semi-circular in cross-section. Similarly the first component 12 has corresponding circumferential grooves 20 defined on the outer surface thereof. The grooves 20 on the second component 10 are arranged to register with the grooves 20 on the first component 12 such that each pair of grooves 20 define an annular passageway in the assembly 11 when the second component 10 abuts the shoulder 18 of the first component 12. Once assembled, ball bearings 21 are arranged to locate within these annular passageways and the ball bearings 21 and the passageway profile cooperate to lock the second component 10 to the first component 12. The ball bearings 21 comprise standard spherical balls that may be of hardened and ground steel or ceramic material.

In order to assemble and construct the joint 11, the flange 12 is placed in a fixture and is heated by electrical induction in order to expand the bore (i.e. to increase the diameter) in order to allow insertion of the pipe 10. The pipe 10 is inserted into the flange bore until the pipe 10 abuts or “bottoms out” on the shoulder 18. The two parts (the flange 12 and the pipe 10) are then allowed to cool to room or ambient temperature at which time a tight interference will have formed. The ball bearings 21 are inserted through a drilled port 22 into the circular groove which is formed when the flange 12 and the pipe 10 are aligned. The quantity of ball bearings 21 is arranged to completely fill the groove(s) 20. A screwed plug is then used to seal the ball entry port 22. This is repeated for each groove 20 if more than one is used.

As previously described, the second component 10 also has a series of circumferential ribs 24 projecting outwardly from the external surface in order to provide a raised profile for engaging with corresponding grooves 26 providing a recessed surface on the internal surface of the flange 12. The separation distances between adjacent grooves 24 (and ribs 26) can be predetermined depending upon the situation. The spacing may be uniform or may be arranged to gradually increase (or decrease) along the longitudinal length of the circumferential contact surfaces.

Finally, the circumferential contact surfaces provided on the outer surface of the pipe 10 and/or the inner surface of the flange 12 may be arranged to be tapered in order to increase the securement between the pipe 10 and the flange 12.

1-25. (canceled)

26. A method of joining one tubular metal component inside another such that the joined components are concentric, with a first larger diameter component surrounding a second smaller diameter component, wherein the internal diameter of the first component is chosen to be equal to or slightly smaller than the external diameter of the second component when both components are at ambient temperature, either the first component is heated or the second component is cooled or both the first component is heated and the second component is cooled such that the internal diameter of the first component is slightly larger than the external diameter of the second component, the first component is fitted over the second component while their temperatures are different, and the temperatures of the components are allowed to reach equilibrium so that the first and second component are in contact with one another over circumferential contact surfaces, wherein the contact surfaces between the components are machined with a surface profile prior to assembly.

27. A method as claimed in claim 26, wherein the surface profile consists of a random surface finish.

28. A method as claimed in claim 26, wherein the surface profile consists of a series of circumferential grooves.

29. A method as claimed in claim 28, wherein the grooves are about 0.1 mm height with about 0.1 mm pitch.

30. A method as claimed in claim 26, wherein the first component is heated by resistance heating.

31. A method as claimed in claim 26, wherein the second component is cooled using liquid nitrogen.

32. A method as claimed in claim 26, wherein the components are mounted in a jig before being fitted together and the jig guides the components as they are fitted together.

33. A method as claimed in claim 26, wherein at least one bore is drilled through the wall of the first component and into but not through the second component, a key is fitted in the hole to extend partly in the first component and partly in the second component, and the key is fixed in place.

34. A method as claimed in claim 33, wherein the key is a ball bearing.

35. A method according to claim 26 in which resistance to separation of the first component and the second component comprises resistance provided by friction between the two components.

36. A method according to claim 26 in which resistance to separation of the first component and the second component comprises a force generated between grooves and ribs provided on the two components.

37. A method according to claim 26 in which resistance to separation of the first component and the second component comprises a force generated between locking elements located in a retaining passageway defined between the two components.

38. A method according to claim 26 in which resistance to separation of the first component and the second component comprises a sum of resistances provided by friction between the two components, a force generated between grooves and ribs provided on the two components and a force generated between locking elements located in a retaining passageway defined between the two components.

39. A riser pipe comprising a plurality of riser sections each having flanges connected to pipes by the method of claim 26, with the flanges connected to one another.

40. A riser section comprising a length of pipe and flanges fitted at each end by a method as claimed in claim 26, wherein the flanges have holes through which bolts can be passed to secure riser sections end to end.

41. An assembly comprising a first tubular metal component and a second tubular metal component, the assembly comprising the second component being secured inside the first component such that the joined components are concentric, wherein the first component comprises a larger diameter which surrounds the second smaller diameter component, the internal diameter of the first component is equal to or slightly smaller than the external diameter of the second component when both components are at ambient temperature, prior to assembly the first component is heated, or the second component is cooled or both the first component is heated and the second component is cooled such that the internal diameter of the first component is slightly larger than the external diameter of the second component, the first component is fitted over the second component while their temperatures are different, and the temperatures of the components are allowed to reach equilibrium so that the first and second components are in contact with one another over circumferential contact surfaces, wherein the contact surfaces between the components are machined with a surface profile prior to assembly.

42. An assembly according to claim 41 in which the first component comprises a series of engaging grooves provided on an inner surface thereof and the second component comprises a series of engaging ribs provided on an outer surface thereof and wherein each engaging rib engages with a corresponding engaging groove in the assembled configuration.

43. An assembly according to claim 42 in which each engaging rib comprises a generally rectangular or square profile and the ribbed surface provides a castellated engaging surface.

44. An assembly according to claim 42 in which each engaging groove comprises a generally rectangular or square profile and the grooved surface provides a castellated engaging surface.

45. An assembly according to claim 41 in which resistance to separation of the first component and the second component comprises resistance provided by friction between the two components.

46. An assembly according to claim 41 in which resistance to separation of the first component and the second component comprises a force generated between grooves and ribs provided on the two components.

47. An assembly according to claim 41 in which resistance to separation of the first component and the second component comprises a force generated between locking elements located in a retaining passageway defined between the two components.

48. An assembly according to claim 41 in which resistance to separation of the first component and the second component comprises a sum of resistances provided by friction between the two components, a force generated between grooves and ribs provided on the two components and a force generated between locking elements located in a retaining passageway defined between the two components.
